(19) United States
(12) Patent Application Publication
(10) Pub. No.: US 2007/0131870 A1
(43) Pub. Date: Jun. 14, 2007

(54) Multiplexed CE fluorescence system

(75) Inventors: Ho Ming Pang, Ames, IA (US); Wei Wei, Ames, IA (US)

Correspondence Address: MCKEE, VOORHEES & SEASE, P.L.C., 801 GRAND AVENUE, SUITE 3200, DES MOINES, IA, 50309-2721, US

(73) Assignee: COMBISEP, Ames, IA (US)

(21) Appl. No.: 11/299,643

(22) Filed: Dec. 12, 2005

(51) Int. Cl. G01J 1/42

(52) U.S. Cl. 250/373

(57) ABSTRACT

A multiplexed capillary electrophoresis (CE) method using fluorescence detection for a plurality of samples is improved economically and in terms of instrument complexity by irradiating the plurality of samples with a single non-coherent light source as the excitation light source for all of the channels. The preferred light source is a light-emitting-diode (LED).

### FIELD OF THE INVENTION

This invention relates to a multiplexed capillary electrophoresis (CE) fluorescence detection system and method that may be used for the separation and detection of substances possessing fluorescent properties, e.g., fluorescently labeled dsDNA, amino acids, carbohydrates, fatty acids, proteins, etc.

### BACKGROUND OF THE INVENTION

There are a variety of commercially available instruments applying electrophoresis to analyze DNA samples. One such type is a multi-lane slab gel electrophoresis instrument, which as the name suggests, uses a slab of gel on which DNA samples are placed. Voltage is applied across the gel slab, which induces the migration of the charged DNA sample. The gel acts as a size-based sieving matrix, resulting in the separation of the DNA sample into DNA fragments of different masses.

Another type of electrophoresis instrument is the capillary electrophoresis (CE) instrument. CE refers to a family of related analytical techniques that use very strong electric fields to separate molecules within narrow-bore capillaries (typically 20-100 μm internal diameter). CE techniques are employed in numerous applications in both industry and academia. Gel- and polymer network-based CE has revolutionized studies of nucleic acids; applications include DNA sequencing, nucleotide quantification, and mutation/polymorphism analysis. By applying electrophoresis in a small diameter fused silica capillary column carrying a buffer solution, the sample size requirement is significantly smaller and the speed of separation and resolution can be increased multiple times compared to the slab gel-electrophoresis method. DNA fragments analyzed by CE are often detected by directing light through the capillary wall, at the components separating from the sample that have been tagged with a fluorescent material, and detecting the fluorescence emissions induced by the incident light. The intensities of the emission are representative of the concentration, amount and/or size of the components of the sample.

Some of the challenges in designing CE-based instruments and performing CE analysis protocols relate to sample detection techniques. In the case of fluorescence detection, considerable design considerations have been given to, for example, radiation source, optical detection, sensitivity and reliability of the detection, and cost and reliability of the structure of the detection optics.

The use of CE with fluorescence detection provides high detection sensitivity for DNA analysis. Fluorescence detection is often the detection method of choice in the fields of genomics and proteomics because of its outstanding sensitivity compared to other detection methods.

Most multiplexed CE systems, whereby multiple capillaries or channels were used to perform separations in parallel, use a laser (coherence light source) as the excitation light source for fluorescence detection (see U.S. Pat. No. 5,582,705). One patent (U.S. Pat. No. 6,828,567) shows a system comprising a light-emitted-diode (LED) associated with each separation channel. Other publications deal with single column detection rather than multiples.

The use of lasers, or a single light-emitting-diode associated with each channel and/or capillary provides complexity to the instrument and an associated increased expense. In the past, it has been thought the use of a single LED for an array of channels and/or capillaries could not be accomplished because a single LED would provide insufficient output and would not be of a high enough power to illuminate the detection windows of an entire array of capillaries and/or channels at once.

Fluorescence detection in capillary electrophoresis (CE) provides outstanding sensitivity compared to standard UV absorption detection. The signals of fluorescence detectors are related to the exciting sample volume and the output power at a specific wavelength of the light source. CE uses narrow-bore capillaries (typically 20-100 μm internal diameter) resulting in nL sample volumes to be detected. Therefore, the output power of light sources is critical to obtain a low limit of detection (LOD) and in order to excite most sample molecules high output light sources are often used. The fluorescence excitation light sources can be a gas discharge lamp (mercury or xenon), a laser (gas, solid state, dye, or semiconductor) or a light-emitting-diode (LED). When a gas discharge lamp was used as the fluorescence excitation source the LOD was only 10 times lower than UV absorption detectors. The breakthrough in CE fluorescence detection was due to the introduction of the laser as a light source. The coherent property of the laser makes it easy to focus onto the small detection windows present in CE. A result of this focusing capability and high power output at a specific wavelength is that the optical power density is much higher than that of a conventional lamp at a selected wavelength. Single molecule detection has been demonstrated with CE employing laser-induced fluorescence (LIF) detectors. In regard to multiplexed capillary systems, several fluorescence detection modes have been developed. Most of them used a laser as the light source, including confocal scanning laser induced fluorescence (e.g. U.S. Pat. No. 6,270,644), sheath flow detectors (e.g. U.S. Pat. Nos. 5,468,364 and 6,048,444) and side-entry optical excitation geometry (e.g., U.S. Pat. Nos. 5,582,705 and 5,741,411).

The main drawback of the sheath flow detector is the highly sophisticated flow system that is needed to ensure a reliable sheath flow. Extreme demands are put on the optical and mechanical component tolerances in order to meet robustness demands of end-users.

The scanning confocal detector is based on scanning the optical system. The use of moving parts is not ideal when considering simplicity, robustness and lower costs of the instrument. The optical scanning principle also reduces the duty cycle per capillary, which may impair the sensitivity when scaling the instrument further for very high-throughput purposes.

Side-entry optical excitation geometry methods illuminate the interior of multiple capillaries simultaneously, and collects the light emitted from them. As in U.S. Pat. No. 5,790,727, the capillaries in a parallel array form an optical wave guide wherein refraction at the cylindrical surfaces confines illuminating light directed in the plane of the array to the core of each adjacent capillary in the array. In order to reduce light scatter, an optical wave-guide was used. Furthermore, a high powered laser source was needed because the laser beam was expanded to illuminate multiple channels.

LEDs as fluorescence excitation light sources have been used in single channel CE. In addition, multiplexed CE with fluorescence detection using LEDs as light sources was disclosed in U.S. Pat. No. 6,828,567. This system is based on a multi-radiation source/common detector configuration, in which detection is conducted in a time-staggered, and/or time-multiplexed detection for the channels. Each capillary was illuminated by a LED through optical fibers. The incident light from the light sources is separately directed to the multi-channel detection zones using optical fibers. The emitted light from the multi-channel detection zones also is directed to one or more common detectors using optic fibers. There may be more than one detector with multiple light sources in the entire detection system, each serving multiple radiation sources. The limitations of this scheme are that the number of multi-channels was limited by time-staggered strategies and detection cycle because of the sampling rate limitations. Therefore, only up to a 12-channel system was commercialized.

LED techniques have developed rapidly in recent years. High powered LED light sources with low cost are available from many commercial sources. The characteristics of LED light are different from lasers or conventional lamps. The LED output is not coherent as in laser light source, however LEDs have a narrow light spectrum and much higher optical output than conventional lamps at a specific wavelength.

It can be seen that in the continuing improvement of multiplexed CE systems there is therefore a need for a system of lower cost and less complexity in design that efficiently demonstrates accurate separation, high resolution and sensitive detection with a low cost of operation. This invention has as its primary goal fulfillment of this need.

### BRIEF SUMMARY OF THE INVENTION

The present invention provides a simplified, low cost, high sensitivity, and high throughput multiplexed, capillary electrophoresis fluorescence detection system comprised of a single non-coherent light source as the excitation light source for all channels. An optical fiber bundle directs the emitted light from the LED to the capillary array detection window at an angle, preferably of about 45° relative to the capillary array holder. The emission output from the samples at the detection window is collected by a camera lens and registered with a two-dimensional imaging detector such as a charged coupled detector (CCD).

### BRIEF DESCRIPTION OF THE DRAWINGS

FIG. 1 is a schematic of a multiplexed electrophoresis system of the present invention that uses fluorescence detection with a single LED light source positioned angularly as the excitation light source for the separation channels.

FIG. 2 depicts a 2D image output from the CCD detector.

FIG. 3 is an electropherogram result showing successful separation and detection using the system of FIG. 1.

### DETAILED DESCRIPTION OF THE PREFERRED EMBODIMENT

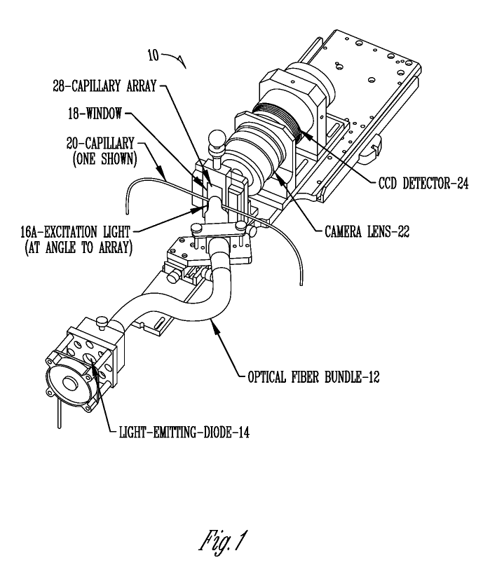

A specific embodiment of the invention is described in connection with FIG. 1. It is, however, to be understood FIG. 1 is exemplary only and that other physical embodiments of the system may be employed without departing from the scope and spirit of the invention.

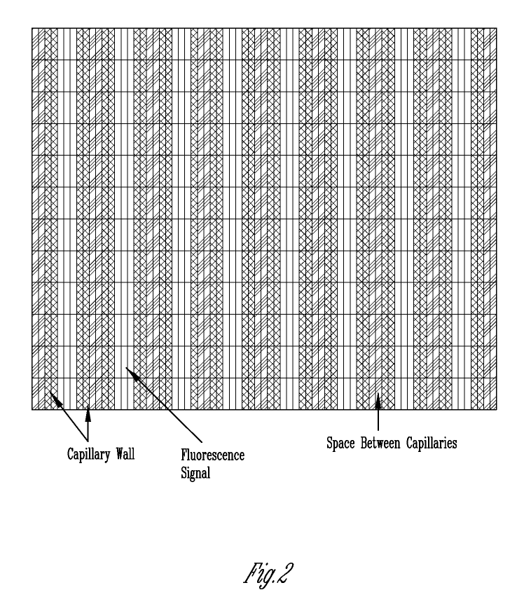

As earlier mentioned, the present invention provides a simple, low cost, efficient, highly sensitive and high throughput detection system referred to generally as 10, based upon an optical fiber bundle 12 used to deliver a single LED light source 14, instead of an expensive high-powered laser in a multichannel detection system, through a window 16, at preferably an acute angle, the angle being most preferably 45°. The angle of this system is illustrated at 16, the window at 18 and one capillary at 20. An optical camera lens 22 is used for collecting the fluorescent signal and is recorded on a two-dimensional imaging array detector such as a charged couple device (CCD) detector 24. In addition, pixel binning from the detector along the detection window signal is used to improve the signal to noise ratio without losing separation resolution. When imaging the fluorescent signal from the detection windows of the capillary array to the CCD detector, each capillary emission signal will cover more than one pixel on the CCD detector. For example, FIG. 2 depicts a 2D image output from the CCD detector while monitoring the detection window fluorescent signal. The fluorescent light from the detection window irradiates onto multiple pixels of the CCD detector. By combining the corresponding signals together (horizontally and vertically), a higher signal to noise ratio of the detection signal call be obtained.

Certain limits and parameters of the system are worthy of mention. Radiant flux of the light-emitting-diode (LED) can generally be from 100 mW to 1000 mW, and preferably is about 700 mW. Although one could use even higher radiant flux for excitation to increase the signal, higher background noise resulting from increased light scatter on the capillary detection surface would offset the gain. Therefore, one could use higher radiant flux if the larger light scatter can be reduced. Light from the diode is collected and illuminated upon the detection window 16 in an angular fashion, preferably at an angle from 20° to 90°, more preferably from 30° to 60° and most preferably at an angle of about 45°. The LED light can be collimated and focused onto the whole detection window; or an optical fiber bundle can be used to collect the light output from the LED light source onto the detection window directly. Using the optical fiber bundle is preferred because it is difficult to reshape the light output from the LED to match the shape of the detection window. However, the optical fiber bundle can be manufactured such that the input end has a similar collection area as the LED light source to maximize the light collection efficiency and the output end has a similar shape to the detection window to maximize the illumination efficiency. When the optical fiber bundle is used, lenses can be used to collimate the light output from the optical fiber bundle to the detection window. In the case of not using lenses, the output end of the optical fiber bundle is positioned as closely as possible to the detection window to minimize divergent output light. The later method is the preferred method because of the simple design.

The separation channels may be a capillary array 28 as illustrated in FIG. 1, or they may in fact be just channels fabricated into a block (not shown). A system that has been used successfully is with the type of 96 capillary array shown for example in Yeung, U.S. Pat. No. 6,788,414 of Sep. 7, 2004.

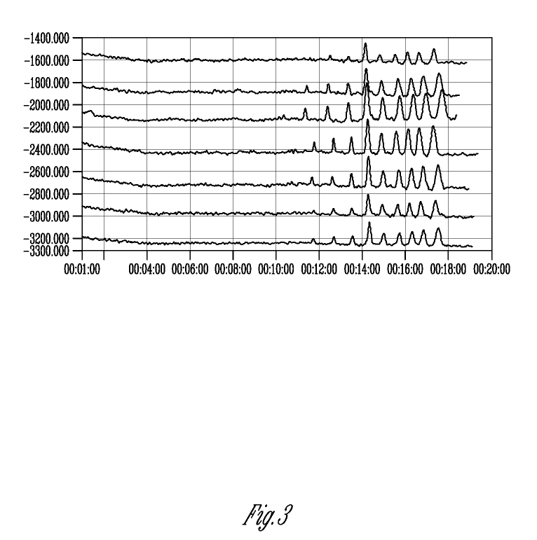

The system of FIG. 1 was utilized for the fluorescence detection of a separated dsDNA sample as an example. The sieving matrix contained a dye such as ethidium bromide that binds to the dsDNA and that fluoresces when excited by the light source. The CCD detector recorded the fluorescence output from the detection windows. Software algorithms were used to extract and re-construct the signal output as electropherograms. FIG. 3 depicts a 100 base pair dsDNA ladder separation. The system showed at least 20 to 100 times better sensitivity than that of a UV absorption detection system comparable in cost.

It therefore can be seen that the invention accomplishes at least all of its stated objectives.

1. In a multiplexed capillary electrophoresis method using fluorescence detection for a plurality of samples located in a plurality of separation channels, the improvement comprising:
irradiating the plurality of samples all at the same time with a single non-coherent light source positioned angularly, as the excitation light source for all of said channels.

2. The method of claim 1 wherein the light source is a light-emitting-diode (LED).

3. The method of claim 2 wherein the LED power output is greater than 100 mW.

4. The method of claim 1 wherein the plurality of samples are in a planar array of capillaries.

5. The method of claim 4 wherein the light source is delivered to a detection window via a fiber bundle at an angle of from 20° to 90°.

6. The method of claim 5 wherein the light source is delivered to a detection window via an optical fiber bundle at an angle from 30° to 60° to said detection window.

7. The method of claim 5 wherein said angle is about 45°.

8-9. (canceled)

10. A multiplexed capillary electrophoresis detection system, comprising:
a plurality of separation channels for separate analytical samples;
a detection system associated with each of said separation channels;
a single non-coherent excitation light source for irradiating all of said samples simultaneously;
a detector for detecting radiation emissions from all of said samples;
wherein the detection of fluorescence by said samples in said planar array of said separation channels indicates the presence of a fluorescent species in said samples.

11. The detection system of claim 10 wherein the separation channels are capillaries.

12. The detection system of claim 11 wherein the single non-coherent excitation light source is a light-emitting-diode (LED).

13. The detection system of claim 10 having a light transmitting window between said single non-coherent excitation light source and said plurality of separation channels.

14. The system of claim 13 wherein said light source is delivered to said detection window by an optical fiber bundle associated with said LED or by a collimated lens associated with said LED.

15. The system of claim 14 wherein the optical fiber bundle is positioned to deliver said light at a 45° angle to said detection window.
